(19) United States
(12) Patent Application Publication
(10) Pub. No.: US 2007/0173553 A1
(43) Pub. Date: Jul. 26, 2007

(54) Waterborne coatings and foams and methods of forming them

(76) Inventor: Edward W. Taylor Jr, Ballwin, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/566,148

(22) PCT Filed: Jul. 29, 2004
(86) PCT No.: PCT/US04/24355

§ 371 Date: Sep. 18, 2006

Related U.S. Application Data
(60) Provisional application No. 60/490,841, filed on Jul. 29, 2003.

(51) Int. Cl. C08J 9/00

(52) U.S. Cl. 521/99

(57) ABSTRACT

Methods of forming epoxy-based foams include reacting at least one sulfonyl hydrazide chemical blowing agent with at least one curing agent at a temperature between 1° C. and about 60° C. Illustratively, the curing agent is an emulsion of an adduct of a polyamine. A low density ambient cured, non-exothermic, closed cell epoxy foam may be formed for use as an insulation. This insulation may be fire retardant or fire resistant. The foam may be applied as a liquid material which then foams under ambient temperatures and pressures, or as a panel which has been pre-cast, and delivered in a slab form. Densities as low as 0.24 g/cm3 (15 lbs./ft3) can be achieved at 24° C. with compressive strengths approaching 1500 psi.

### CROSS-REFERENCE TO RELATED APPLICATIONS

This application claims the benefit of U.S. Provisional application 60/490,841 filed Jul. 29, 2003, incorporated by reference herein.

### TECHNICAL FIELD

The present invention is directed generally to waterborne polymers. In one embodiment, it is directed to foams and methods of producing foams. In some preferred embodiments it is directed to methods of producing epoxy-based foams at ambient temperatures and pressures. In another embodiment, it is directed to fire-resistant epoxy coatings formed at ambient temperature, illustratively room temperature. The invention has particular, but not exclusive, use in the preparation of fire-resistant foams.

### BACKGROUND ART

Historically, foamed polymeric matrices have been used for insulation of walls, tanks, ceilings, and other structures. One example is insulation of liquid natural gas (LNG) tanks. Presently, such tanks are covered with an insulative polymeric foam, which is then covered with a fire resistant coating. Polymeric foams have also been used as structural elements. Certain modified foams have also been used for fire protection. These foams have been made from various materials including urethane, epoxy, polyimides, phenolics, silicones and the like, which are formed using a process referred to as blowing. General discussions of polymeric foams and their methods of generation are found in the background sections of, for example, Lee et al., U.S. Pat. No. 6,583,190 and Garcia et al., U.S. Pat. No. RE. 35,447. Blowing may occur during polymerization, or in a softened polymer. Blowing may be accomplished using either chemical or physical blowing agents.

Physical blowing agents are substances which are themselves gases at the working temperature of the foaming process. They may either be injected as gases or else change state, typically from liquid to gas at the temperature and pressure of foam production. Physical blowing agents require additional equipment and are difficult to control.

Chemical blowing agents undergo a chemical change (usually by decomposition but sometimes by reacting with another composition) to generate a gas. For most chemical blowing agents, an elevated temperature is necessary to trigger the gas-generating chemical change. The agents come in various forms, each with its own temperature of activation, generally in the range of 105° C.-260° C. (232° F.-500° F.). Commercially, polymeric foams such as epoxy foams are generally formed with either an exothermic chemical blowing agent that decomposes to form nitrogen gas or an endothermic chemical blowing agent that forms carbon dioxide gas as it absorbs heat. Chemical blowing agents are well known and are described, for example, in Grubb, U.S. Pat. No. 6,346,292 and Perez et al., U.S. Pat. No. 6,323,251.

Although current physical and chemical blowing techniques have been successfully used to produce foams, a need still exists for other more desirable blowing techniques. Aside from the obvious complexity added by elevated temperatures and the physical dangers they engender, the temperatures could result in unwanted characteristics in the foamed product. Additionally, these temperatures could restrict the types of additives used in the foam to give the foam other desirable properties such as fire retardance and fire resistance.

Other methods of blowing foams exist, but they are generally of limited applicability. For example, one cumbersome approach is frothing the polymer by mechanically stirring the liquid polymer or at least one liquid ingredient of the polymer in the presence of a gas, usually a pressurized gas. Although frothing can produce a foamed epoxy matrix, control over the process must be strict to avoid under- or over-frothing, which will result in foam that lacks the desired properties. Frothing can also be used only in a limited number of applications. Examples of frothing are disclosed in Wilson et al., U.S. Pat. No. 3,969,286 and Hanafin et al., U.S. Pat. No. 6,096,812.

Still another method of forming a polymeric foam is taught in McCullough, Jr., U.S. Pat. No. 5,223,324 wherein a polyurethane/isocyanate fire retardant foam or expanded polystyrene foam is made by using reduced atmospheric conditions to blow the foam.

Still another method of creating an epoxy foam is taught in LeMay, U.S. Pat. No. 5,116,883 in which an epoxy foam is created by using liquid carbon dioxide, and vaporizing off the carbon dioxide under super critical conditions.

A need exists for foam-producing methods that are not labor intensive and do not require elevated processing temperatures or reduced pressures.

The present invention also relates to fire-resistant polymers, particularly fire-resistant intumescent epoxy-based polymers. Broadly, such polymers are also known and are in widespread use. When exposed to fire or other hyperthermal condition, intumescent fire-resistant polymers swell to more than five times their original thickness and form a protective matrix. The expanded matrix is generally a closed-cell char. These are solvent-borne systems having volatile organic compounds (VOC's) that are pollutants and add to the cost and complexity of applying the polymers as coatings on substrates. Moreover, epoxy-based fire resistant intumescent coatings and foams are relatively heavy. Although they can be frothed, as described for example by Hanafin et al., U.S. Pat. No. 6,096,812, their density is still greater than about 0.8 g/cm³ (50 lbs/ft³).

### SUMMARY OF THE INVENTION

In accordance with one aspect of the present invention, a method of forming a polymeric foam is provided that includes reacting a sulfonyl hydrazide chemical blowing agent with a curing agent to form the foam, wherein the curing agent is a waterborne polyamine or polyamide. In some embodiments, the foam is epoxy based. In some embodiments the polyamine is a waterborne emulsion of an adduct of a polyamine. As used herein, the term “waterborne” includes not only solutions but also emulsions, whether the emulsion is regarded as being an oil-in-water emulsion or as a water-in-oil emulsion. In some embodiments the curing agent is a waterborne emulsion of an epoxy adduct of a polyamide-amine. The process is preferably substantially isothermic. The process is carried out at a temperature below the activation temperature of the chemical blowing agent.

Foams, including epoxy-based foams and other foams, formed by this method are also provided.

Resin systems which can produce the foams of the invention are also provided.

In accordance with another aspect of the invention, a low density, epoxy-based intumescent fire resistive coating is provided having a density less than about 0.8 g/cm³, preferably 0.6 g/cm³ or less. Preferably, the epoxy-based fire resistant polymers are waterborne. Preferably they include a sulfonyl hydrazide blowing agent and an amine or amide curing agent, a char-forming polyol, and a gas-forming agent.

In accordance with another aspect of the invention, a waterborne epoxy-based intumescent fire resistant polymer is provided. In one embodiment, the intumescent polymer is applied to a substrate as a coating.

### BEST MODES FOR CARRYING OUT THE INVENTION

Unique and reproducible methods of forming stable foam products have been discovered that are not labor intensive and do not require either elevated processing temperature or reduced pressure. The foams are illustratively epoxy-based foams, and these foams are presently preferred for certain applications. One method comprises reacting at least one sulfonyl hydrazide chemical blowing agent with at least one curing agent to form the foam, wherein the curing agent is a waterborne polyamide, preferably an emulsion of an adduct of a polyamide.

In accordance with the methods described herein, epoxy-based foams may be produced at room temperature, as well as at a wide range of temperatures above and below room temperature, to suit particular applications. As used herein the phrase “room temperature” means in the range of about 15° C. to about 30° C. (60° F. to about 85° F.). Accordingly, there is no need for careful temperature control during the curing process, or the use of noxious catalysts or hazardous ingredients. The foams of the invention may be produced with no practical upper limit on temperature other than that imposed by the thermal stability of the polymer and the activation temperature of the blowing agent. The process temperature is preferably less than about 60° C., more preferably at a temperature between about 1° C. and 40° C. The process is conveniently and preferably carried out at ambient temperature, which is frequently room temperature.

The methods of the invention may also be practiced at normal atmospheric pressure (approximately 760 torr), or at a wide range of ambient pressures, or at any other convenient pressure to suit the application. Further, the foaming methods of the invention are surprisingly neither exothermic, nor endothermic, but appear to be substantially isothermal. Because of the favorable reaction conditions, the present foaming methods may be conveniently practiced at a job site or in numerous other applications which have been difficult or impossible with presently known foaming methods.

The foams that are produced by the ingredients and by the methods described herein are also within the scope of the present invention. The foams formed may be lightweight, low density, ambient-cured, closed-cell foams that may be used for insulation, protective coatings, as well as for other purposes. The presently preferred foams are epoxy-based, but other binders or resins may be used. An adduct of epoxy may be utilized in the epoxy-based resins to provide desired characteristics, such as flexibility, as is known in the art. An epoxy/polysulfide adduct is preferred for some applications. It has been found that merely the sulfonyl hydrazide chemical blowing agent and the waterborne polyamide will together form a foam having desirable properties. Therefore, the system may in principle be utilized with any resin system compatible with these constituents.

The foams may be applied to substrates, for example cement or structural steel, as liquid materials, which then foam under ambient temperatures and pressures, or as solid panels that have been pre-cast and delivered, or they may be cast or formed as structural or insulative elements.

The density of the foams produced varies based on many factors, including the amount of blowing agent used, the viscosity of the curing system, the rate of the curing system, the type of epoxy resin used, the type of curing agent used, the degree of external pressure, the conditions of polymerization, and the presence and type of fillers used. Viscosities between about 5,000 centipoise and 200,000 centipoise (cps) are presently preferred. The rigidity of the foams also varies based on many factors, including the pigment load, types of fillers used, degree of polymerization and degree of cross-linking between the epoxy resins and chemical blowing agents employed. The foams can be applied by any known method of applying foams, including extrusion, casting the foams into molds and hand or spray application.

The foams may include optional adjuvants. For example, surfactants may be useful in preparing the foams. The surfactants may include polar and non-polar surfactants that can be anionic, cationic, or nonionic. Other additives useful in the invention include, by way of example, thixotropic agents, tackifiers (e.g., rosin esters, terpenes, phenols, and aliphatic, aromatic, or mixtures of aliphatic and aromatic synthetic hydrocarbon resins), plasticizers (other than physical blowing agents), nucleating agents such as talc, silicon, -or titanium dioxide, hydrophobic or hydrophilic silica, calcium carbonate, flame retardants, finely ground polymeric particles, toughening agents such as those taught in Tarbutton et al., U.S. Pat. No. 4,846,905, pigments, dyes, fillers including high-solubility fillers, low-solubility fillers which may provide better water resistance, and density reducing fillers such as perlite, glass beads or microspheres, and ceramic beads or microspheres, expandable microspheres, abrasive granules, stabilizers, light stabilizers, antioxidants, flow agents, bodying agents, flatting agents, colorants, binders, fungicides, bactericides, and reinforcing materials such as woven and nonwoven webs of organic and inorganic fibers, such as polyester fibers, polyimide fibers, glass fibers, carbon fibers, and ceramic fibers. Other additives as known to those skilled in the art can be added to the compositions of this invention. These can be added in an amount effective for their intended purpose; typically, amounts up to about 25 parts of adjuvant per total weight of formulation can be used. The additives can modify the properties of the basic composition to obtain a desired effect. The desired properties are largely dictated by the intended application of the foam or foam article. Furthermore, the additives can be reactive components such as materials containing reactive hydroxyl functionality. Alternatively, the additives can be also substantially unreactive, such as fillers, including both inorganic and organic fillers.

Lower density may also be achieved by the addition of one or more additional physical or chemical blowing agents or by frothing.

At least one curing agent must be utilized in the methods of the invention to produce the foams of the invention. In accordance with one embodiment of the invention, the curing agents comprise polyamines or polyamides. In accordance with another embodiment the curing agents comprise polyamide-amines. In accordance with another embodiment of the invention the curing agents comprise transaminated Mannich bases. These agents may be used alone, or in combination with other suitable curing agents. The preferred curing agents are waterborne adducts of polyamines, usually primary polyamines. Emulsions are preferred. Because of the nature of the curing mechanism, the foams will cure and retain adhesion in 100% humidity and even under water. Among the curing agents that are appropriate for the methods of the invention are waterborne epoxy curing agents that are emulsions of an epoxy adduct, the reaction product of a poly alkylene oxide monoamine or diamine and a diepoxide or a polyepoxide then reacted with a polyamine or a polyamide, or the reaction product of a polyalkylene oxide monoalcohol and a polyepoxide, which is then reacted with a polyamine or a polyamide. Examples of suitable curing agents useful in the methods of the invention, include, but are not limited to products available under the trademarks Anquamine® 701 (Epilink 701), Anquamine® 401, Anquamide® 360 (Epilink 360), and Epilink 660, which are all sold by Air Products and Chemicals of Allentown, Pa., Epikure® 8535, which is sold by Resolution Performance Products, LLC of Houston, and Texas, Aradur® 340, which is sold by Vantico Group S.A. of Luxembourg. Gaskamine 328, which is sold by Mitsubishi Gas Chemical America, Inc. of New York, N.Y. is also believed to be useable. Detailed methods for making useable curing agents are described in Klipstein, U.S. Pat. No. 5,854,312. Many or all of these products contain carbonyl groups. Other curing agents useful in the methods of the invention are known or will be obvious to those skilled in the art.

Preferably, the curing agent comprises about 30% to about 70% of the combined weight of the resin, curing agent, and blowing agent. In some embodiments the curing agent comprises about 40% to about 60%. In some embodiments, the curing agent comprises about 30% to about 70% by weight of the ingredients making up the cured resin. However, the use of concentrations outside of these range is also contemplated.

At least one sulfonyl hydrazide-based chemical blowing agent is employed in the methods of the invention. The chemical blowing agents may be used alone, or in combination. The preferred sulfonyl hydrazide chemical blowing agents are p-toluenesulfonylhydrazide and p,p′-oxybis(benzenesulfonyl-hydrazide). These are available from Uniroyal, Inc. of Middlebury, Conn., under the trademarks Celogen® TSH and Celogen® OT, respectively. It should be noted that other sulfonyl hydrazide blowing agents may be utilized in the methods of the invention. Well-known examples are 2,4-toluenedisulfonylhydrazide, p-methylurethane benzene-sulfonylhydrazide, benzenesulfonylhydrazide, benzene-1,3-disulfonylhydrazide, diphenylsulfone-3,3′-disulfonylhydrazide, and sulfone hydrazide. The blowing agents that are preferred in the compositions and methods of the invention have activation temperatures which are above the temperature at which the foam is produced in accordance with the methods of the invention. Nonetheless, the gas produced on reaction of the foaming agent is trapped in the resin as it polymerizes and forms a uniform and controllable foam.

Preferably, the chemical blowing agent comprises about 0.01% to about 15% of the combined weight of the resin, curing agent, and blowing agent. In some embodiments, the blowing agent comprises about 1% to about 10%. In some embodiments, the blowing agent comprises about 0.01% to about 15% by weight of the ingredients making up the cured resin. However, the use of concentrations outside of these range is also contemplated.

When the resin is an epoxy resin, any epoxy resin that is capable of cross-linking with the curing agents described herein is suitable for use in the methods of the invention. The resins are added to the foams to improve flexibility and to decrease the hardness of the foams. Suitable epoxy resins include, but are not limited to, Bisphenol A or Bisphenol F liquid epoxy resins. However, the use of numerous other epoxy resins, including modified resins is also contemplated. Modifications may include, for example, rubber-modified, acrylic-modified, polysulfide-modified resins, and flexibilized resins as disclosed in Feldman et al., WO 02/070622.

Merely by way of example, a wide variety of commercial epoxides are available and listed in “Handbook of Epoxy Resins” by Lee and Neville, McGraw Hill Book Company, New York (1967) and in “Epoxy Resin Technology” by P. F. Bruins, John Wiley & Sons, New York (1968), and in “Epoxy Resins: Chemistry and Technology, 2^{nd} Edition” by C. A. May, Ed., Marcel Dekker, Inc. New York (1988). Aromatic polyepoxides (i.e., compounds containing at least one aromatic ring structure, e.g., a benzene ring, and at least two epoxide groups) include the polyglycidyl ethers of polyhydric phenols, such as Bisphenol A- or Bisphenol-F type resins and their derivatives, aromatic polyglycidyl amines (e.g., polyglycidyl amines of benzenamines, benzene diamines, naphthylenamines, or naphthylene diamines), polyglycidyl ethers of phenol formaldehyde resole or novolak resins; resorcinol diglycidyl ether; polyglycidyl derivatives of fluorene-type resins; and glycidyl esters of aromatic carboxylic acids, e.g., phthalic acid diglycidyl ester, isophthalic acid diglycidyl ester, trimellitic acid triglycidyl ester, and pyromellitic acid tetraglycidyl ester, and mixtures thereof. Useful aromatic polyepoxides are the polyglycidyl ethers of polyhydric phenols, such as the series of diglycidyl ethers of Bisphenol-A, (for example, those available under the trade designations “EPON 828,” “EPON 1004”, “EPON 1001F,” “EPON 825,” and “EPON 826,” available from Resolution Performance Productions, Houston, Tex.; and “DER-330,” “DER-331,” “DER-332,” and “DER-334”, available from Dow Chemical Company, Midland, Mich.); diglycidyl ether of Bisphenol F (for example, those under the trade designations EPON” Resin 862”, available from Resolution Performance Productions, Houston, Tex.; and “ARALDITE GY 281, GY 282, GY 285, PY 306, and PY 307”, available from Vantico, Brewster, N.Y.); 1,4-butanediol diglycidyl ether (for example, having the trade designation “ARALDITE RD-2” available from Vantico, Brewster, N.Y.); and polyglycidyl ether of phenol-formaldehyde novolak (for example, having the trade designation “DEN-431 ” and “DEN-438” available from Dow Chemical Company, Midland, Mich.). Examples of useful mono, di and multifunctional glycidyl ether resins include, but are not limited to, “XB 4122”, “MY0510”, “TACTIX 556” and “TACTIX 742”, available from Vantico, Brewster, N.Y.; and “EPON 1510”, “HELOXY Modifier 107” and “HELOXY Modifier 48” available from Resolution Performance Productions, Houston, Tex. Representative aliphatic cyclic polyepoxides (i.e., cyclic compounds containing one or more saturated carbocyclic rings and at least two epoxide groups, also known as alicyclic compounds) useful in the present invention include the series of alicyclic epoxides commercially available from Dow Chemical, Midland, Mich., under the trade designation “ERL”, such as vinyl cyclohexene dioxide (“ERL-4206”), 3,4-epoxycyclohexylmethyl-3,4-epoxycyclo-hexane carboxylate (“ERL-4221”), 3,4-epoxy-6-methylcyclohexylmethyl-3,4-epoxy-6-methylcyclohexane carboxylate (“ERL-4201”), bis(3,4-epoxy-6-methylcycylohexylmethyl)adipat-e (“ERL-4289”), and dipentenedioxide (“ERL-4269”). Representative aliphatic polyepoxides (i.e., compounds containing no carbocyclic rings and at least two epoxide groups) include 1,4-bis(2,3-epoxypropoxy)butane, polyglycidyl ethers of aliphatic polyols such as glycerol, polypropylene glycol, 1,4-butanediol, and the like, the diglycidyl ester of linoleic acid dimer, epoxidized polybutadiene (for example, those available under the trade designation “OXIRON 2001” from FMC Corp., Philadelphia, Pa. or “Poly bd” from Elf Atochem, Philadelphia, Pa.), epoxidized aliphatic polyurethanes, and epoxy silicones, e.g., dimethylsiloxanes having cycloaliphatic epoxide or glycidyl ether groups.

In one embodiment of the invention, a fire retardant is introduced into the foam to impart fire resistance to the foam. In specific embodiments of the invention, the illustrative epoxy foam of the invention may be rendered fire resistant by the introduction of one or more of the following: phosphates, endothermic fillers, char forming agents, tris(hydroxyethyl)isocyanurates (THEIC) and polyfunctional alcohols. Other fire resistive additives are well known to those skilled in the art and may for example include titanium dioxide, zinc, boron, calcium carbonate, and numerous proprietary materials which are widely available such as IFR 36 (Clariant) and Budit 3118F (Budenheim). Reinforcing fabrics and fibers are commonly utilized. The adjuvants previously identified for inclusion in foams may be utilized.

As is well known to those skilled in the art, a proper mixture of fire retardants, combined with an appropriate resin, will produce a material that form a char when exposed to fire or hyperthermal conditions. The char-forming compositions may operate by various modalities. The compositions may be used in various forms, including thick film (mastic) coatings, thin film coatings, castings, extrusions, and others. The compositions may include organic or inorganic binders and various additives. Upon exposure to heat the compositions slowly lose weight as portions of the composition are volatilized, and a char is formed which provides a measure of protection against the transfer of heat energy. Eventually, the char is consumed by physical erosion and by chemical processes, primarily oxidation by oxygen in the air and by free radicals produced by the coating or otherwise in a fire environment, and protection is lost. The length of time required for a given temperature rise across a predetermined thickness of the composition, under specified heat flux, environmental, and temperature conditions, is a measure of the effectiveness of the composition in providing thermal protection.

When subjected to fire or other hyperthermal conditions, different coatings behave differently.

Ablative coatings swell to less than twice their original thickness. They provide limited passive thermal protection, but they tend to produce dense chars having good physical and chemical resistance.

Intumescent coatings swell to produce a char more than five times the original thickness of the coating. This char provides an insulative blanket which provides superior thermal efficiency, but at the cost of some of the physical and chemical properties of the ablative coatings. The char of the intumescent materials tends to form coarse and irregular cell structures, cracks, and fissures as it expands, and the char may not expand uniformly at corners, leaving areas where the char provides far less protection than the average thermal protection of the underlying structure. Examples of the intumescent systems include silicate solutions or ammonium phosphate paints or mastic compositions such as those disclosed in Nielsen et al., U.S. Pat. No. 2,680,077, Kaplan, U.S. Pat. No. 3,284,216, Ward et al., U.S. Pat. No. 4,529,467, or Deogon, U.S. Pat. No. 5,591,791.

A third type of char-forming coating is a subliming coating disclosed in Feldman, U.S. Pat. No. 3,849,178. When subjected to thermal extremes, these compositions both undergo an endothermic phase change and expand two to five times their original thickness to form a continuous porosity matrix. These coatings tend to be tougher than intumescent coatings. They provide far longer thermal protection than ablative coatings, frequently longer than intumescent coatings, in part because the gasses formed by the endothermic phase change provide active cooling as they work their way through the open-cell matrix. These coatings may also have a tendency to crack and form voids and fissures.

The present invention may provide thermal protective coatings, particularly fire retardant and fire resistant coatings, of all of these types, depending on the resin system and the fire-resistive adjuvants chosen. The adjuvants may be any known to those skilled in the art, including those described for foams. The presently preferred embodiments of fire-resistant coatings of the invention are epoxy-based foam systems which produce intumescent chars when exposed to hyperthermal temperatures.

The fire-resistant foams of the present invention will provide a great improvement over numerous known foams in many applications. For example, using the foams of the invention on LNG tanks may make the use of fire-resistant coatings over the foam, as now commonly required, unnecessary. Similar improvements are possible by substituting the present foams for those used as cushions, as structural insulation, and in many other applications.

In accordance with other embodiments of the invention, curable waterborne resin systems are provided which produce fire-resistant epoxy resins in the form of coatings which may be applied in various ways such as by rolling, troweling, spraying or the like, or in the form of cast, molded, or extruded forms. The systems include the epoxy resins and curing agents described herein, with or without the blowing agents. Without the blowing agents, fire-resistant and fire-retardant polymers are formed which have many desirable qualities, without requiring the use of organic solvents and their attendant VOC's.

Although the present invention permits the production of foams having low densities, smaller quantities of the blowing agent may be utilized with the curing agent to produce cured polymeric materials having densities only slightly less than the densities without these components. Therefore, the present invention permits the production of coatings and shapes having a wide range of precisely controlled densities.

Although it is preferred that the binder of the polymeric system include at least some epoxy-based material to react with the curing agent, other binder systems can be utilized. Merely by way of example, latexes, polysulfides, silicones, alkyds, acrylics, polyimides, aramids, phenolics, and the vinyl toluene acrylate of Deogon, U.S. Pat. No. 5,591,791 may be foamed using the combined blowing agent and curing agent of the invention in accordance with the method of the invention. If components are not included in the resin system which react with the curing agent, either as a cross-linker or otherwise, then the unreacted amine or amide curing agent will remain in the polymer. This may be beneficial, for example by acting as a pH buffer.

The following EXAMPLES are illustrative of materials and methods of the invention.

### EXAMPLE 1

An illustrative example of a foam of the present invention was formed as follows.

| | |
|---|---|
| Epoxy resin | 34.6% |
| Anquamine ® 701 | 55.4% |
| Celogen ® OT | 10.0% |

The epoxy resin is a Bis-A resin having an epoxide equivalent weight of about 190 and a viscosity of about 8,000-15,000 cps. Anquamine 701 is a 60% water dispersion of a waterborne emulsified polyamine curing agent. Celogen OT is p,p′-oxybis(benzene)sulfonyl hydrazide. The materials listed above were mixed. Visible foaming begins in about ninety minutes, and visible foaming ceases after about six hours. The resultant mixture had a wet density equal to 1.14 grams per cubic centimeter (71.35 pounds per cubic foot). The mixture spontaneously foamed at room temperature to form a closed-cell, epoxy-based foam having a fine cell structure. The foam formed at room temperature, had a dry density equal to 0.293 g/cm³ (18.29 lbs/ft³), and had a compressive strength, 10% yield, equal to 65.1 kg/cm² (926 lbs/in²).

### EXAMPLE 1A

Other foams were formed in the same manner. Their compositions and characteristics are shown in Table I and Table II. These tables show experiments in which the epoxy resin component ranged from 30% to 70% by weight of the wet mixture, the Anquamine curing agent ranged from 30% to 70% by weight of the wet mixture, and the blowing agent (Celogen OT in Table I and Celogen TSH in Table II) ranged from 0% to 10% by weight of the wet mixture. Samples of each formulation were mixed at room temperature, at 1.7° C. (35° F.), and at 37.8° C. (100° F.). At any of these temperatures, the mixtures containing both the curing agent and the blowing agent spontaneously foamed and cured. The dry materials formed upon curing of the mixtures blown at room temperature had densities ranging from 0.242 g/cm³ (15.1 lb/ft³) using 10% Celogen TSH to 1.14 g/cm³ (71 lb/ft³) using 0% blowing agent; using 1% blowing agent (Celogen OT) yielded densities as high as 0.623 g/cm³ (38.9 lb/ft3). Compressive strengths of the foams blown at room temperature ranged from 5.7 kg/cm² (81 psi) to 651 kg/cm² (9261 psi).

TABLE I

| | | | | Density @ | | Compressive | Density at | Hardness @ | Compressive |
|---|---|---|---|---|---|---|---|---|---|
| | Epoxy | Celogen | Anquamine | RT (lbs/ | Hardness @ | Strength RT | 35° F. | 35° F. | Strength |
| Sample | Resin | OT | 701 | ft³) | RT (D) | (lbs/ft²) | (lbs/ft³) | (D) | 35° F. |
| 1 | 0.6 | 0.1 | 0.3 | 27.82 | 0 | 81 | 34.97 | 0 | 23 |
| 2 | 0.45 | 0.1 | 0.45 | 21.25 | 32 | 1236 | 27.95 | 39 | 1693 |
| 3 | 0.7 | 0 | 0.3 | 68.59 | 61 | 9262 | 71.06 | 0 | 0 |
| 4 | 0.3 | 0 | 0.7 | 66.67 | 65 | 4716 | 67.63 | 70 | 4858 |
| 5 | 0.5 | 0 | 0.5 | 64.63 | 80 | 5517 | 69.34 | 74 | 7048 |
| 6 | 0.3 | 0.1 | 0.6 | 19.54 | 24 | 887 | 29.61 | 44 | 1577 |
| 7 | 0.3 | 0.05 | 0.65 | 19.2 | 23 | 860 | 27.36 | 40 | 1637 |
| 8 | 0.65 | 0.05 | 0.3 | 25.66 | 0 | 570 | 33.18 | 0 | 73 |
| 9 | 0.4 | 0 | 0.6 | 62.67 | 76 | 5471 | 66.75 | 74 | 6550 |
| 10 | 0.6 | 0 | 0.4 | 66.94 | 78 | 7063 | 68.43 | 62 | 7566 |
| 11 | 0.37 | 0.05 | 0.58 | 19.52 | 28 | 964 | 27.68 | 33 | 1747 |
| 12 | 0.58 | 0.05 | 0.37 | 24.73 | 37 | 1335 | 31.92 | 30 | 1799 |
| 13 | 0.38 | 0.01 | 0.61 | 33.89 | 51 | 2154 | 42.1 | 60 | 2986 |
| 14 | 0.61 | 0.01 | 0.38 | 38.87 | 57 | 28.5 | 42.44 | 43 | 3753 |
| 15 | 0.373 | 0.03 | 0.597 | 21.04 | 34 | 1158 | 31.17 | 46 | 2323 |
| 16 | 0.597 | 0.03 | 0.373 | 22.96 | 0 | 297 | 31.04 | 0 | 38 |
| 17 | 0.346 | 0.1 | 0.554 | 18.29 | 32 | 926 | 29.62 | 46 | 1832 |
| 18 | 0.554 | 0.1 | 0.346 | 23.68 | 38 | 1128 | 31.34 | 44 | 1707 |
| 19 | 0.358 | 0.07 | 0.572 | 18.55 | 30 | 982 | 29.36 | 45 | 1855 |
| 20 | 0.572 | 0.07 | 0.358 | 23.64 | 9 | 328 | 31.97 | 0 | 146 |

| | | | Compressive | Wet |
|---|---|---|---|---|
| | Density @ | | Strength | Density |
| | 100° F. | Hardness @ | 100° F. | (lbs/ |
| Sample | (lbs/ft³) | 100° F. (D) | (lbs/ft²) | ft³ ) |
| 1 | 18.53 | 29 | 662 | 72.82 |
| 2 | 14.09 | 20 | 685 | 71.94 |
| 3 | 62.71 | 88 | 10034 | 71.06 |
| 4 | 58.11 | 76 | 4468 | 68.87 |
| 5 | 65.5 | 79 | 6277 | 69.95 |
| 6 | 10.31 | 13 | 425 | 71.09 |
| 7 | 12.88 | 16 | 376 | 69.96 |
| 8 | 16.62 | 27 | 623 | 71.93 |
| 9 | 64.61 | 80 | 4989 | 69.41 |
| 10 | 68.47 | 88 | 6413 | 70.15 |
| 11 | 13.14 | 13 | 423 | 70.35 |
| 12 | 14.85 | 24 | 709 | 71.52 |
| 13 | 26.77 | 44 | 1590 | 69.52 |
| 14 | 31.17 | 50 | 2260 | 70.78 |
| 15 | 15.94 | 22 | 640 | 69.92 |
| 16 | 16.03 | 20 | 506 | 71.16 |
| 17 | 13.62 | 15 | 395 | 71.35 |
| 18 | 16.33 | 30 | 640 | 72.54 |
| 19 | 13.29 | 16 | 438 | 70.73 |
| 20 | 16.43 | 18 | 606 | 71.94 |

TABLE II

| | | | | | | Compressive | Density at | |
|---|---|---|---|---|---|---|---|---|
| | Epoxy | Celogen | Anquamine | Density @ RT | Hardness @ | Strength RT | 35° F. | Hardness @ |
| Sample | Resin | TSH | 701 | (lbs/ft³ ) | RT (D) | (lbs/ft²) | (lbs/ft³) | 35° F. (D) |
| 21 | 0.6 | 0.1 | 0.3 | 24.68 | 20 | 92.5 | 31.68 | 6 |
| 22 | 0.45 | 0.1 | 0.45 | 15.07 | 26 | 686 | 22.11 | 30 |
| 23 | 0.7 | 0 | 0.3 | 71 | 37 | 7222 | 71 | 0 |
| 24 | 0.3 | 0 | 0.7 | 67.77 | 72 | 6353 | 69.24 | 72 |
| 25 | 0.5 | 0 | 0.5 | 63.26 | 80 | 6894 | 68.94 | 72 |
| 26 | 0.3 | 0.1 | 0.6 | 15.2 | 17 | 490 | 20.89 | 24 |
| 27 | 0.3 | 0.05 | 0.65 | 18.44 | 24 | 670 | 25.84 | 39 |
| 28 | 0.65 | 0.05 | 0.3 | 23.57 | 17 | 307 | 32.59 | 0 |
| 29 | 0.4 | 0 | 0.6 | 62.62 | 78 | 5706 | 68.29 | 78 |
| 30 | 0.6 | 0 | 0.4 | 68.02 | 85 | 8408 | 68.21 | 63 |
| 31 | 0.37 | 0.05 | 0.58 | 18.5 | 27 | 1016 | 27.58 | 44 |
| 32 | 0.58 | 0.05 | 0.37 | 21.95 | 32 | 1164 | 26.77 | 34 |
| 33 | 0.38 | 0.01 | 0.61 | 33.7 | 54 | 2480 | 40.98 | 60 |
| 34 | 0.61 | 0.01 | 0.38 | 38.43 | 61 | 3203 | 42.37 | 50 |
| 35 | 0.373 | 0.03 | 0.597 | 22.03 | 35 | 1314 | 28.9 | 50 |
| 36 | 0.597 | 0.03 | 0.373 | 26.92 | 40 | 1705 | 31 | 37 |
| 37 | 0.346 | 0.1 | 0.554 | 15.98 | 23 | 608 | 21.66 | 34 |
| 38 | 0.554 | 0.1 | 0.346 | 16.79 | 23 | 491 | 20.91 | 27 |
| 39 | 0.358 | 0.07 | 0.572 | 17.69 | 24 | 946 | 25.78 | 40 |
| 40 | 0.572 | 0.07 | 0.358 | 18.1 | 23 | 616 | 22.47 | 30 |

| | | | | Compressive | |
|---|---|---|---|---|---|
| | Compressive | Density @ | | Strength | Wet |
| | Strength | 100° F. | Hardness @ | 100° F. | Density |
| Sample | 35° F. | (lbs/ft³) | 100° F. (D) | (lbs/ft²) | (lbs/ft³) |
| 21 | 199.5 | 17.73 | 20 | 201 | 72.31 |
| 22 | 1266 | 12.7 | 24 | 404 | 71.45 |
| 23 | 0 | 71.11 | 90 | 9075 | 71.06 |
| 24 | 5846 | 61.72 | 72 | 5406 | 68.87 |
| 25 | 7891 | 67.47 | 84 | 6923 | 69.95 |
| 26 | 595 | 12.56 | 12 | 213 | 70.61 |
| 27 | 1396 | 13.9 | 17 | 342 | 69.73 |
| 28 | 148 | 18.53 | 34 | 449 | 71.68 |
| 29 | 7505 | 65.19 | 78 | 5616 | 69.41 |
| 30 | 8680 | 68.23 | 89 | 8545 | 70.5 |
| 31 | 2088 | 13.86 | 21 | 519 | 70.11 |
| 32 | 1540 | 15.39 | 23 | 864 | 71.28 |
| 33 | 2892 | 27.96 | 44 | 1899 | 69.47 |
| 34 | 3688 | 32.25 | 54 | 2462 | 70.73 |
| 35 | 2464 | 17.16 | 22 | 849 | 69.78 |
| 36 | 2263 | 17.93 | 30 | 1057 | 71.02 |
| 37 | 1351 | 12.97 | 15 | 313 | 70.86 |
| 38 | 1083 | 12.96 | 16 | 272 | 72.05 |
| 39 | 1849 | 13.36 | 20 | 323 | 70.4 |
| 40 | 714 | 14.55 | 21 | 548 | 71.6 |

### EXAMPLE 2

A fire retardant foam was formed from the following materials.

| | |
|---|---|
| Epoxy resin | 27.7% |
| Anquamine ® 701 | 44.3% |
| Celogen ® OT | 8.0% |
| Ammonium Polyphosphate | 5.0% |
| Melamine | 5.0% |
| Dipentaerythritol | 5.0% |
| Melamine Pyrophosphate | 5.0% |

The substances listed above were admixed to produce a fine textured epoxy-based foam comparable to the foams of Tables I and II. The foam was then subjected to a two-minute propane test, wherein the foam was subjected to an 800° C. flame from a propane torch. Prior to the propane test, the original weight was 5.630 grams, the thickness was 1.16 cm (0.458 inches) and the density was 0.283 g/cm³ (17.69 lbs/ft³). After the propane test, the foam weighed 4.856 grams, had a char height of 2.65 cm (1.008 inches) and a thickness (of the remaining foam) of 1.10 cm (0.434 inches). After the propane test 94.76% of the foam remained, and the expansion from the used foam was 42×.

### EXAMPLE 2A

Twenty-four samples were made as above, having the compositions shown in Table III. In addition to the ingredients listed above, some contained commercially available fire-resistant additives, including titanium dioxide, IFR-36, a proprietary product of Clariant containing THEIC and ammonium polyphosphate, and BUDIT 3118F, a proprietary phosphate ester from Budenheim-Iberica which combines a spumific (blowing agent),-acid donor (catalyst) and carbonific (char former). All produced fine-textured foams having characteristics comparable to those of corresponding foams in Table I.

TABLE III

| | Epoxy | Celogen | Anquamine | Ammonium | | | Melamine | Clariant | Titanium | Budit |
|---|---|---|---|---|---|---|---|---|---|---|
| Sample | Resin | OT | 701 | Polyphosphate | Melamine | Dipentaerythritol | Pyrophospahate | IFR-36 | Dioxide | 3118F |
| 41 | 0.311 | 0.09 | 0.499 | 0.05 | 0.025 | 0.025 | 0 | 0 | 0 | 0 |
| 42 | 0.294 | 0.085 | 0.471 | 0.076 | 0.037 | 0.037 | 0 | 0 | 0 | 0 |
| 43 | 0.277 | 0.08 | 0.443 | 0.1 | 0.05 | 0.05 | 0 | 0 | 0 | 0 |
| 44 | 0.329 | 0.095 | 0.526 | 0.025 | 0.012 | 0.013 | 0 | 0 | 0 | 0 |
| 45 | 0.311 | 0.09 | 0.499 | 0.025 | 0.025 | 0.025 | 0.025 | 0 | 0 | 0 |
| 46 | 0.294 | 0.085 | 0.471 | 0.038 | 0.037 | 0.037 | 0.038 | 0 | 0 | 0 |
| 47 | 0.277 | 0.08 | 0.443 | 0.05 | 0.05 | 0.05 | 0.05 | 0 | 0 | 0 |
| 48 | 0.329 | 0.095 | 0.526 | 0.013 | 0.012 | 0.012 | 0.013 | 0 | 0 | 0 |
| 49 | 0.311 | 0.09 | 0.499 | 0 | 0 | 0 | 0 | 0.1 | 0 | 0 |
| 50 | 0.294 | 0.085 | 0.471 | 0 | 0 | 0 | 0 | 0.15 | 0 | 0 |
| 51 | 0.277 | 0.08 | 0.443 | 0 | 0 | 0 | 0 | 0.2 | 0 | 0 |
| 52 | 0.329 | 0.095 | 0.526 | 0 | 0 | 0 | 0 | 0.05 | 0 | 0 |
| 53 | 0.311 | 0.09 | 0.499 | 0.044 | 0.022 | 0.022 | 0 | 0 | 0.012 | 0 |
| 54 | 0.294 | 0.085 | 0.471 | 0.066 | 0.033 | 0.033 | 0 | 0 | 0.018 | 0 |
| 55 | 0.277 | 0.08 | 0.443 | 0.088 | 0.044 | 0.044 | 0 | 0 | 0.024 | 0 |
| 56 | 0.329 | 0.095 | 0.526 | 0.022 | 0.011 | 0.011 | 0 | 0 | 0.006 | 0 |
| 57 | 0.311 | 0.09 | 0.499 | 0 | 0 | 0 | 0 | 0 | 0 | 0.1 |
| 58 | 0.294 | 0.085 | 0.471 | 0 | 0 | 0 | 0 | 0 | 0 | 0.15 |
| 59 | 0.277 | 0.08 | 0.443 | 0 | 0 | 0 | 0 | 0 | 0 | 0.2 |
| 60 | 0.329 | 0.095 | 0.526 | 0 | 0 | 0 | 0 | 0 | 0 | 0.05 |
| 61 | 0.311 | 0.09 | 0.499 | 0 | 0 | 0 | 0 | 0 | 0.012 | 0.088 |
| 62 | 0.294 | 0.085 | 0.471 | 0 | 0 | 0 | 0 | 0 | 0.018 | 0.132 |
| 63 | 0.277 | 0.08 | 0.443 | 0 | 0 | 0 | 0 | 0 | 0.024 | 0.176 |
| 64 | 0.329 | 0.095 | 0.526 | 0 | 0 | 0 | 0 | 0 | 0.006 | 0.044 |

The foams of Table III were subjected to a two-minute propane test as described above. The results, using the same units as in Example 2, are set out in Table IV.

TABLE IV

| | Original | Weight | Original | Thickness of Foam | | After | | | Expansion |
|---|---|---|---|---|---|---|---|---|---|
| | Weight | after test | Thickness of | After Test (without | Char Height | Burn | % Foam | % Weight | from used |
| Sample | (grams) | (grams) | foam (inches) | char) (inches) | (inches) | (sec) | Remaining | Remaining | Foam |
| 41 | 7.722 | 6.217 | 0.478 | 0.384 | 0.642 | 4 | 80.33% | 80.51% | 6.83 |
| 42 | 8.057 | 6.808 | 0.465 | 0.412 | 0.802 | 2 | 88.60% | 84.50% | 15.13 |
| 43 | 7.693 | 6.525 | 0.420 | 0.369 | 0.625 | 0 | 87.86% | 84.82% | 12.25 |
| 44 | 7.113 | 1.242 | 0.437 | 0.000 | 0.000 | 19.64 | 0.00% | 17.46% | 0.00 |
| 45 | 6.306 | 1.992 | 0.443 | 0.000 | 0.000 | 26.73 | 0.00% | 31.59% | 0.00 |
| 46 | 5.828 | 4.494 | 0.459 | 0.350 | 0.843 | 0 | 76.25% | 77.11% | 7.73 |
| 47 | 5.630 | 4.856 | 0.458 | 0.434 | 1.008 | 0 | 94.76% | 86.25% | 42.00 |
| 48 | 6.273 | 0.526 | 0.437 | 0.000 | 0.000 | 15.59 | 0.00% | 8.39% | 0.00 |
| 49 | 6.543 | 6.506 | 0.435 | 0.381 | 1.175 | 0 | 87.59% | 99.43% | 21.76 |
| 50 | 7.936 | 7.092 | 0.435 | 0.388 | 0.981 | 0 | 89.20% | 89.36% | 20.87 |
| 51 | 8.958 | 7.965 | 0.475 | 0.419 | 1.026 | 0 | 88.21% | 88.91% | 18.32 |
| 52 | 7.438 | 4.099 | 0.442 | 0.203 | 0.514 | 11.12 | 45.93% | 55.11% | 2.15 |
| 53 | 7.026 | 4.280 | 0.447 | 0.247 | 0.645 | 12.26 | 55.26% | 60.92% | 3.23 |
| 54 | 7.457 | 6.032 | 0.455 | 0.362 | 0.987 | 7 | 79.56% | 80.89% | 10.61 |
| 55 | 7.440 | 6.344 | 0.432 | 0.368 | 1.000 | 0 | 85.19% | 85.27% | 15.63 |
| 56 | 6.482 | 0.635 | 0.422 | 0.000 | 0.000 | 43.93 | 0.00% | 9.80% | 0.00 |
| 57 | 6.719 | 4.026 | 0.421 | 0.240 | 0.619 | 3.73 | 57.01% | 59.92% | 3.42 |
| 58 | 6.694 | 5.000 | 0.421 | 0.318 | 1.138 | 0 | 75.53% | 74.69% | 11.05 |
| 59 | 6.271 | 4.730 | 0.432 | 0.300 | 0.846 | 0 | 69.44% | 75.43% | 6.41 |
| 60 | 6.320 | 0.578 | 0.405 | 0.000 | 0.000 | 16.8 | 0.00% | 9.15% | 0.00 |
| 61 | 4.669 | 1.460 | 0.422 | 0.000 | 0.000 | 28.94 | 0.00% | 31.27% | 0.00 |
| 62 | 4.566 | 2.927 | 0.410 | 0.240 | 0.984 | 4.54 | 58.54% | 64.10% | 5.79 |
| 63 | 5.485 | 3.946 | 0.440 | 0.268 | 1.010 | 3.4 | 60.91% | 71.94% | 5.87 |
| 64 | 5.208 | 0.504 | 0.400 | 0.000 | 0.000 | 6.97 | 0.00% | 9.68% | 0.00 |

### EXAMPLE 3

An illustrative fire-resistant epoxy-based foam of the invention was formed as follows.

| | |
|---|---|
| Part A | |
| Epoxy Resin | 33 g |
| Celogen OT | 6.6 g |
| Ammonium Polyphosphate | 7.9 g |
| Melamine | 3.6 g |
| Dipentaerythritol | 3.6 g |
| Part B | |
| Anquamine ® 701 | 40 g |
| Titanium Dioxide | 5 g |

Parts A and B were mixed together and placed in a mold on a steel Q-panel with a nominal 2 inches of normal weight concrete poured on the opposite side. A thermocouple was imbedded in the concrete at the surface of the steel to monitor the steel temperature during a fire. Another thermocouple was placed on the free surface of the concrete. Once allowed to foam and cure, the sample was subjected to a small-scale fire. The test was concluded after 75 minutes. The results are shown in Table V, all values being expressed in degrees Celsius. For reference, a bare steel panel was tested to show its response, as was a steel panel coated in the same manner with the foam of Example 1. The test was concluded after 75 minutes.

TABLE V

| | | | EXAMPLE 3 | | EXAMPLE 1 | |
|---|---|---|---|---|---|---|
| | Un Protected | | FR-Protected | | Foam Only Protected | |
| | Steel | Concrete | Steel | Concrete | Steel | Concrete |
| Minutes | (° C.) | (° C.) | (° C.) | (° C.) | (° C.) | (° C.) |
| 0 | 21 | 21 | 23 | 23 | 20 | 20 |
| 1 | 126 | | 23 | | 21 | |
| 2 | 162 | | 23 | | 23 | |
| 3 | 185 | | 24 | | 32 | |
| 4 | 201 | | 25 | | 104 | |
| 5 | 215 | | 26 | | 186 | |
| 6 | 227 | | 28 | | 134 | |
| 7 | 238 | | 29 | | 118 | |
| 8 | 248 | | 31 | | 117 | |
| 9 | 258 | 61 | 32 | 26 | 119 | 32 |
| 10 | 267 | | 34 | | 125 | |
| 11 | 276 | | 35 | | 127 | |
| 12 | 284 | | 37 | | 130 | |
| 13 | 290 | | 38 | | 134 | |
| 14 | 298 | | 40 | | 137 | |
| 15 | 305 | 70 | 42 | 28 | 141 | 47 |
| 16 | 311 | | 43 | | 149 | |
| 18 | 323 | | 46 | | 154 | |
| 19 | 329 | | 48 | | 157 | |
| 20 | 334 | | 50 | | 161 | |
| 21 | 339 | | 51 | | 165 | |
| 22 | 343 | 86 | 53 | 32 | 169 | 61 |
| 23 | 347 | | 54 | | 175 | |
| 24 | 351 | | 55 | | 180 | |
| 25 | 355 | | 57 | | 183 | |
| 26 | 358 | | 58 | | 187 | |
| 27 | 361 | | 59 | | 191 | |
| 28 | 365 | | 60 | | 194 | |
| 29 | 369 | | 61 | | 197 | |
| 30 | 372 | 107 | 62 | 36 | 200 | 78 |
| 31 | 375 | | 63 | | 203 | |
| 35 | 386 | 115 | 66 | 38 | 215 | 85 |
| 40 | 397 | 122 | 74 | 40 | 228 | 93 |
| 45 | 406 | 130 | 84 | 43 | 240 | 96 |
| 50 | 412 | 134 | 92 | 44 | 250 | 100 |
| 55 | 416 | 139 | 98 | 47 | 258 | 106 |
| 60 | 420 | 142 | 105 | 51 | | |
| 65 | 424 | 144 | 109 | 54 | 272 | 112 |
| 70 | 427 | 145 | 116 | 55 | | |
| 75 | 429 | 144 | 120 | 57 | 282 | 116 |

Numerous variations in the compositions and methods of the present invention, within the scope of the appended claims, will occur to those skilled in the art in light of the foregoing disclosure.

The patents and articles referred to herein are hereby incorporated by reference.

1. A method of forming a foam, the method comprising reacting at least one sulfonyl hydrazide chemical blowing agent with at least one curing agent to form the foam, wherein the curing agent reacts with the blowing agent at a temperature below an activation temperature of the blowing agent.

2. The method of claim 1 wherein the curing agent comprises a waterborne polyamide or polyamine.

3. The method of claim 2 wherein the curing agent comprises an adduct of a transaminated Mannich base.

4. The method of claim 2 wherein the curing agent comprises an emulsion of an epoxy adduct of a polyamine.

5. The method of claim 4 wherein the epoxy adduct comprises an epichlorhydrin adduct.

6. The method of claim 4 wherein the curing agent comprises an emulsion of an epoxy adduct of a polyamide-amine.

7. The method of claim 2 wherein the curing agent comprises an emulsion of an epoxy adduct, the reaction product of a poly (alkylene oxide) momoamine or diamine and a di or polyepoxide, then reacted with a polyamine or a polyamide, or the reaction product of a poly(alkylene oxide) monoalcohol and a polyepoxide, which is then reacted with a polyamine or a polyamide.

8. The method of any of claims 1-7 wherein reacting the at least one sulfonyl hydrazide chemical blowing agent with the at least one curing agent is carried out in the presence of a binder, the binder forming the foam with the blowing agent and the curing agent.

9. The method of claim 8 wherein the binder comprises a resin.

10. The method of claim 9 wherein the resin comprises an epoxy-based resin, the curing agent cross-linking the epoxy-based resin.

11. The method of claim 10 wherein the epoxy-based resin comprises an epoxy-terminated polysulfide.

12. The method of claim 8 wherein the binder comprises a latex.

13. The method of any of claims 8-12 wherein the sulfonyl hydrazide blowing agent comprises about 0.01% to about 15% by weight of the sum of the weights of the blowing agent, the curing agent, and the binder.

14. The method of any of claims 8-13 wherein the curing agent comprises about 30% to about 70.0% by weight of the sum of the weights of the blowing agent, the curing agent, and the binder.

15. The method of claim 1 wherein the sulfonyl hydrazide blowing agent comprises about 0.01% to about 15% of the foam by weight.

16. The method of claim 15 wherein the sulfonyl hydrazide blowing agent comprises about 1% to about 10% of the foam by weight.

17. The method of any of claims 1-16 further comprising introducing at least one fire retardant into the foam.

18. The method of claim 17 wherein the fire retardant is selected from the group consisting of phosphates, endothermic fillers, char forming agents, tris(hydroxyethyl)isocyanurates, and polyfunctional alcohols.

19. The method of claim 1 further comprising reacting at least one epoxy-based resin with the curing agent.

20. The method of claim 8 wherein the epoxy-based resin is a bisphenol A type epoxy resin.

21. The method of claim 8 wherein the epoxy-based resin is a bisphenol F type epoxy resin.

22. The method of any of claims 1-21 wherein the at least one chemical blowing agent is p-toluenesulfonylhydrazide.

23. The method of any of claims 1-21 wherein the at least one chemical blowing agent is p,p′-oxybis(benzenesulfonylhydrazide).

24. The method of any of claims 1-23 further comprising introducing at least one low-density filler into the epoxy-based foam.

25. A method of forming an epoxy-based foam, the method comprising reacting a sulfonyl hydrazide with at least one curing agent, and at least one epoxy-based resin at a temperature between about 1° C. and about 60° C. to form the epoxy-based foam.

26. The method of claim 25 wherein the curing agent is a waterborne polyamine or polyamide.

27. The method of claim 26 wherein the curing agent is an emulsion of an adduct of a polyamine.

28. The method of any of claims 25-27 further comprising introducing at least one fire retardant into the epoxy-based foam, wherein the epoxy-based resin is capable of cross-linking with the at least one curing agent.

29. A foam produced by the method of claim 1.

30. The foam of claim 29 wherein the foam comprises an epoxy or modified epoxy resin.

31. The foam of claim 29 or 30 wherein the foam formed in a mold.

32. The foam of claim 29 or 30 wherein the foam is formed by spraying a two-component mixture onto a substrate.

33. A fire resistant foam produced by the method of claim 17.

34. The foam of claim 33 wherein the foam comprises an epoxy or modified epoxy resin.

35. The epoxy-based foam of claim 34 wherein the foam is applied as a protective coating on a substrate.

36. A waterborne foamable resin system comprising a resin, a sulfonyl hydrazide chemical blowing agent, the chemical blowing agent having an activation temperature, and a curing agent, the curing agent comprising an amine or an amide, wherein the curing agent is capable of reacting with the blowing agent at a temperature below the activation temperature of the blowing agent to form a foam.

37. The system of claim 36 wherein the curing agent is capable of cross-linking the resin at room temperature, and the curing agent is capable of reacting with the blowing agent at room temperature.

38. The system of claim 36 or 37 wherein the curing agent comprises an adduct of a polyamine.

39. The system of any of claims 36-38 wherein the resin is an epoxy-based resin.

40. The system of claim 39 wherein the epoxy-based resin is a Bisphenol A type resin or a Bisphenol F type resin.

41. The system of any of claims 36-40 further comprising at least one fire retardant.

42. The system of claim 41 wherein the fire retardant is at least one selected from the group consisting of phosphates, endothermic fillers, char forming agents, tris(hydroxyethyl)isocyanurates, and polyfunctional alcohols.

43. The system of any of claims 36-42 wherein the sulfonyl hydrazide chemical blowing agent comprises about 0.01% to about 15% of the system by weight.

44. The system claim 43 wherein the sulfonyl hydrazide chemical blowing agent comprises about 1% to about 10% of the system by weight.

45. The system of any of claims 36-44 wherein the resin comprises about 25% to about 70% of the system by weight.

46. The system of any of claims 36-45 the curing agent comprises about 30% to about 70% of the system by weight.

47. A foam produced from the system of any of claims 36-46.

48. The foam of claim 47 having a density of less than 0.6 g/cm³.

49. A foam comprising the reaction product of a sulfonyl hydrazide and a waterborne polyamine or waterborne polyamine.

50. The foam of claim 49 wherein the waterborne polyamide is an emulsion of an adduct of a polyamine.

51. The foam of claim 49 or 50 further comprising at least one low-density filler.

55. A two-part chemical blowing agent comprising a sulfonyl hydrazide and a waterborne emulsion of a polyamine.

56. A method of forming a polymeric foam comprising reacting a sulfonyl hydrazide and a waterborne polyamine or waterborne polyamide at generally ambient temperature and generally ambient pressure.

57. A waterborne curable resin system for producing a fire-resistant cured epoxy-based resin, the system comprising an epoxy-based resin, a curing agent, the curing agent comprising a waterborne emulsion of an adduct of a polyamideamine, the curing agent being capable of curing the resin at room temperature, and at least one fire retardant.

58. The system of claim 57 wherein the fire retardant is selected from the group consisting of phosphates, endothermic fillers, char forming agents, tris(hydroxyethyl)isocyanurates, and polyfunctional alcohols.

59. The system of claim 58 wherein the fire retardant comprises a phosphate.

60. A cured composition of any of claims 57-59.

61. A method of protecting a substrate from fire or other hyperthermal conditions, the method comprising applying the composition of claim 60 to the substrate.

62. A substrate with a coating of the composition of claim 60 applied thereto.

63. A low density, epoxy-based intumescent fire resistive coating having a density less than about 0.7 g/cm³.

64. The coating of claim 63 wherein the coating has a density no greater than about 0.4 g/cm³.

65. The coating of claim 63 or 64 wherein the coating is formed from a waterborne resin.

66. The coating of any of claims 63-65 wherein the coating includes the reaction product of a sulfonyl hydrazide blowing agent.

67. The coating of any of claims 63-66 wherein the coating includes a char-forming polyol and a gas-forming agent.
